(19) United States
(12) Patent Application Publication
(10) Pub. No.: US 2026/0099764 A1
(43) Pub. Date: Apr. 9, 2026

(54) SYSTEMS AND METHODS FOR DETERMINISTIC AI/ML MODELS

(71) Applicant: Verizon Patent and Licensing Inc., Basking Ridge, NJ (US)

(72) Inventors: Ahmed A. Khan, Plano, TX (US); Abdul Raheem, Irving, TX (US); Mohammed Alsadi, Redmond, WA (US); Rasmi Ranjan Samal, Hyderabad (IN)

(73) Assignee: Verizon Patent and Licensing Inc., Basking Ridge, NJ (US)

(21) Appl. No.: 18/909,546

(22) Filed: Oct. 8, 2024

(51) Int. Cl. G06N 20/00

(52) U.S. Cl. CPC G06N 20/00

(57) ABSTRACT

A system described herein may maintain a first set of models (e.g., artificial intelligence/machine learning ("AI/ML") models), where a particular model of the first set of models associates a particular set of attributes, a particular input type, and a particular set of output tuning parameters. The system may generate or select one or more outputs based on the particular set of output tuning parameters, and associate the one or more outputs with the particular model. The system may compare a set of attributes, associated with a received input, with the set of attributes included in the particular model, determine that the received input is associated with the particular input type, identify the one or more outputs with which the particular model is associated; and provide a response to the received input, where the response is based on the identified one or more outputs with which the particular model is associated.

### BACKGROUND

Artificial intelligence/machine learning ("AI/ML") techniques, such as Natural Language Processing ("NLP"), computer vision, neural networks, deep learning, K-means clustering, classification, and/or other techniques, may be used to generate models that may be generated or trained, based on training data, to perform operations to generate a set of outputs based on a given set of inputs. One example type of AI/ML model is a large language model ("LLM"), which may be trained based on relatively large amounts of language-related data, such as textual content of books or literature, automated crawling of network-accessible resources (e.g., websites or other network-accessible content), etc. Once trained, an LLM may be used to generate responses to language-based input such as queries, statements, textual input, or the like.

### BRIEF DESCRIPTION OF THE DRAWINGS

FIG. 1 illustrates an example overview of one or more embodiments described herein;

FIG. 2 illustrates an example of one or more input classification models, in accordance with some embodiments;

FIGS. 3-6 illustrate an example of generating one or more tuned outputs for a given input type, in accordance with some embodiments;

FIG. 7 illustrates an example of providing an output in accordance with tuning parameters associated with a given input type, in accordance with some embodiments;

FIG. 8 illustrates an example process for providing an output in accordance with tuning parameters associated with a given input type, in accordance with some embodiments;

FIGS. 9 and 10 illustrate example environments in which one or more embodiments, described herein, may be implemented;

FIG. 11 illustrates an example arrangement of a radio access network ("RAN"), in accordance with some embodiments;

FIG. 12 illustrates an example arrangement of an Open RAN ("O-RAN") environment in which one or more embodiments, described herein, may be implemented; and

FIG. 13 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

AI/ML models may be used to identify or generate one or more outputs based on a given set of inputs. For example, AI/ML models may be trained based on training data to generate or identify a set of computations, calculations, transformations, or other suitable types of operations to perform when provided a given set of inputs, where performing such operations results in a set of outputs. As one example, LLMs may be trained based on relatively large amounts of language data (e.g., books, newspapers, network-accessible resources, databases, social media content, etc.) to generate or identify responses to language-based input such as queries, statements, textual input, or the like. As LLMs typically determine or generate such outputs in a procedural manner. For example, a portion of a response, such as a particular word of a sentence, may be generated or identified based on preceding portions of the response (e.g., previously identified words of the sentence and/or of other sentences). In this manner, responses generated by LLMs may be non-deterministic or random, inasmuch as it may be difficult or impossible to predict the nature of the responses to a given input. For instance, in different situations or in repeated iterations, the same LLM may provide widely varying responses to the same exact input, thus providing a degree of unreliability and unpredictability to the LLM.

Embodiments described herein may provide for AI/ML models that generate more predictable outputs in response to respective sets of input, thus providing increased reliability and predictability of such AI/ML models. As such, any device or system that incorporates the use of AI/ML models may make use of such models to improve the efficiency, reliability, resource consumption, etc. of such devices or systems. An example of such a system may include a wireless network that adjusts network parameters such as Quality of Service ("QoS") parameters, radio access network ("RAN") beamforming parameters, routing parameters, Cloud-Native Network Function ("CNF") deployment parameters, or the like, may be able to use AI/ML models, generated in accordance with some embodiments, to improve the efficiency and overall operation of the wireless network. As another example, an automated customer support center may make use of LLMs, generated in accordance with some embodiments, to generate automated responses that adhere to policies, rules, etc. that dictate characteristics appropriate responses to customer queries, complaints, etc. While LLMs are sometimes discussed herein as an example type of AI/ML model for the sake of explanation, similar concepts may apply other types of AI/ML models.

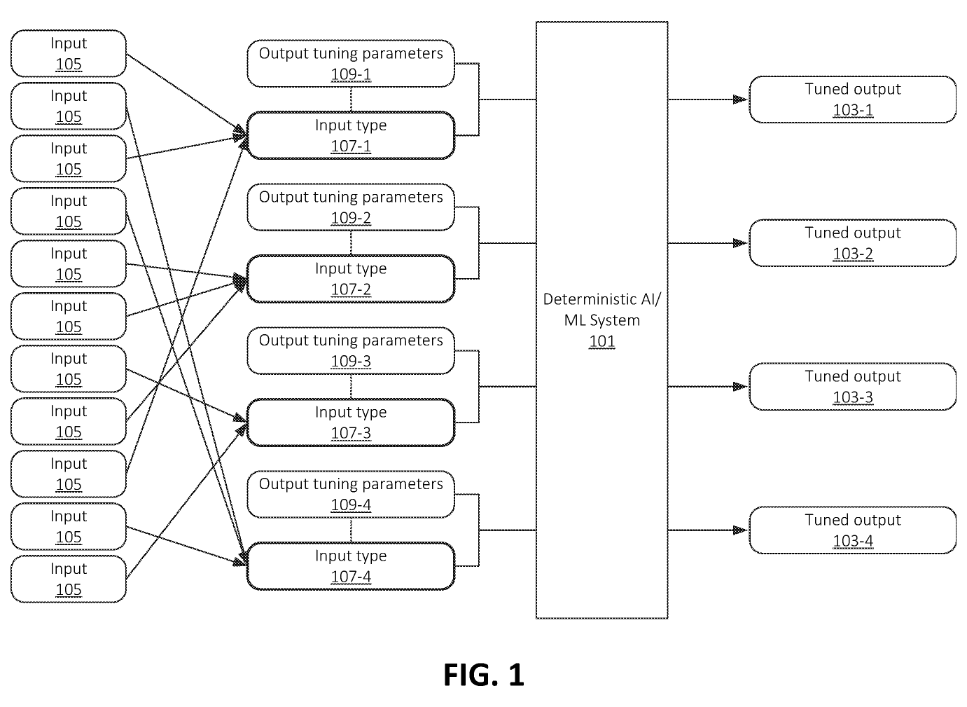

FIG. 1 illustrates an example scenario, in accordance with some embodiments, in which deterministic outputs are generated by Deterministic AI/ML System ("DAS") 101 based on a variety of different inputs. In some embodiments, the outputs of DAS 101 (e.g., tuned outputs 103, including example tuned outputs 103-1, 103-2, 103-3, and 103-4) may include responses generated using one or more LLM techniques, in addition to techniques described herein. For example, tuned outputs 103 may include responses to various diverse inputs 105, which may include queries, questions, statements, or the like.

As discussed herein, DAS 101 may classify, categorize, label, etc. different inputs 105 as being associated with respective input types 107. While the term input "types" is used herein, similar concepts may apply to classifications, categories, labels, groups, attributes, etc. of respective inputs 105. As one example, a first input type 107-1 may include a query regarding a first topic, a second input type 107-2 may include a query regarding a second topic, and so on (e.g., in an embodiment in which DAS 101 utilizes LLMs to generate responses to language-based input). As another example, a first input type 107-1 may include a request for RAN configuration information for a first location of a wireless network, and a second input type 107-2 may include a request for RAN configuration information for a second location of the wireless network.

In accordance with some embodiments, each input type 107 may be associated with a respective set of output tuning parameters 109. For example, input type 107-1 may be associated with a first set of output tuning parameters 109-1, input types 107-2 may be associated with a second set of output tuning parameters 109-2, and so on. Output tuning parameters 109 may be used to provide a level of determinism and predictability to outputs, responses, etc. generated for different input types 107. For example, respective output tuning parameters 109 may specify or include templates, constraints, rules, policies, formats, etc. based on which outputs (e.g., tuned outputs 103) can be generated in response to respective inputs 105 associated with a given input type 107.

As one example (e.g., in an embodiment in which DAS 101 utilizes LLMs to generate responses to language-based input), a first set of output tuning parameters 109-1 may specify a first set of conversational or language-based parameters (e.g., "temperature," diction, restricted words, a response format, etc.), a second set of output tuning parameters 109-2 may specify a second set of conversational or language-based parameters, and so on. As another example, a first set of output tuning parameters 109-1 may include a first set of policies, constraints, values, etc. for a particular set of RAN configuration parameters, and a second set of output tuning parameters 109-2 may include a second set of policies, constraints, values, etc. for the same set (or a different set) of RAN configuration parameters.

As discussed herein, DAS 101 may implement one or more models (e.g., LLMs or other types of AI/ML models) that have been trained, based on output tuning parameters 109, to associate particular input types 107 with respective tuned outputs 103. As discussed herein, tuned outputs 103 for respective input types 107 may be selected or generated based on a scoring, ranking, etc. of outputs (e.g., non-deterministic outputs, which are not necessarily generated based on output tuning parameters 109) that are generated in response to respective inputs. Generally, for example, a given tuned output 103 for a particular input type 107 may be, or may be based on, the most highly scored outputs that were generated in response to inputs associated with the particular input type 107. In accordance with some embodiments, the scoring or ranking may reflect a measure of adherence, a measure similarity, etc. between such outputs and output tuning parameters 109 for the particular input type 107. In this manner, tuned outputs 103 maintain the creative and non-uniform nature of AI/ML techniques such as LLM techniques, while allowing for a measure of determinism, predictability, and tunability to outputs generated by such AI/ML techniques.

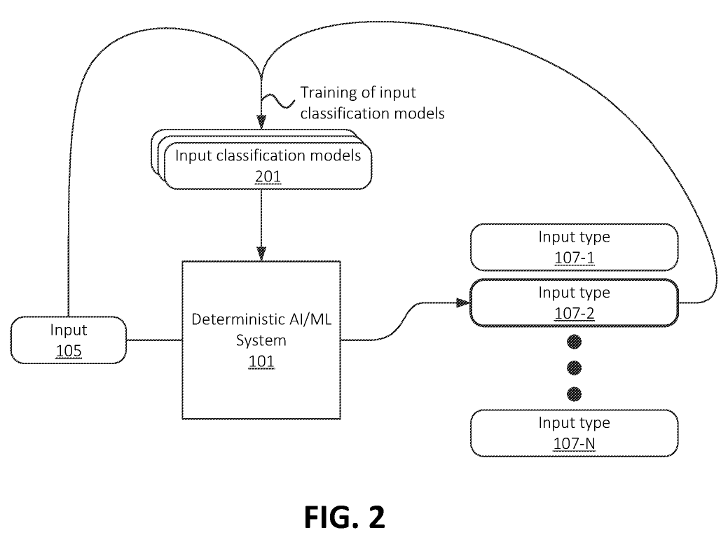

FIG. 2 illustrates an example of associating a respective input 105 with a particular input type 107. DAS 101 may receive, generate, maintain, refine, etc. one or more input classification models 201. Input classification models 201 may specify characteristics, attributes, etc. of inputs that are associated with respective input types 107. For example, a given input classification model 201 may associate a given input 105 with a first set of characteristics or attributes. Such characteristics or attributes may include, as non-limiting examples, a set of keywords or phrases, an indication of a particular user or device from which input 105 was received, a time of day at which input 105 was generated or received, a geographical location indicated in input 105, an identifier of one or more base stations indicated in input 105, and/or other suitable characteristics or attributes.

The example of FIG. 2 conceptually illustrates both the generation, training, refinement, etc. of input classification models 201 as well as the use of input classification models 201 to identify a respective input type 107 for a given input 105. For example, after associating input 105 with a respective input type 107 (e.g., input type 107-2, in the example shown in FIG. 2), DAS 101 may modify or refine one or more input classification models 201 based on feedback, scoring, etc. of the association of input 105 with input type 107-2. For example, if the feedback indicates that input type 107-2 is an accurate or fitting classification for input 105, one or more weights, affinities, factors, etc. of input classification models 201 may be modified to increase the likelihood of associating the same or similar input 105 (e.g., inputs having the same or similar characteristics or attributes as input 105) with the same input type 107-2. On the other hand, if the feedback indicates that input type 107-2 is not an accurate or fitting classification for input 105, input classification models 201 may be modified to decrease the likelihood of associating the same or similar input 105 with the same input type 107-2.

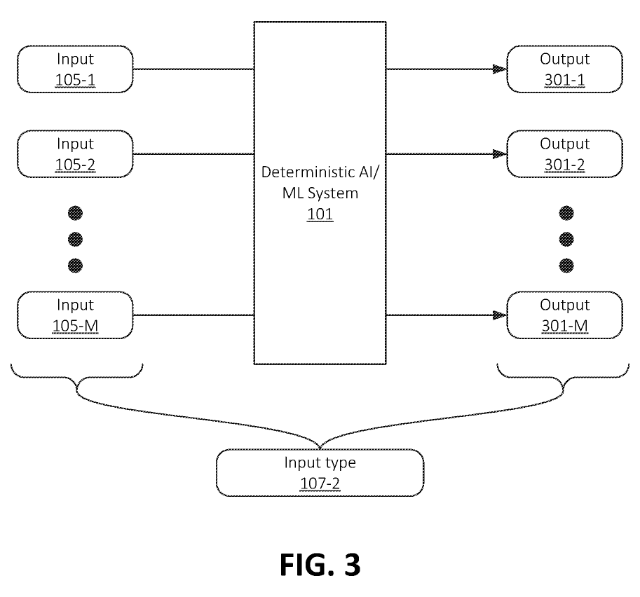

FIGS. 3-6 illustrate an example of generating or identifying a particular tuned output 103 for a given input type 107 based on output tuning parameters 109 associated with input type 107. As shown in FIG. 3, for example, DAS 101 may receive a plurality of inputs 105 (e.g., inputs 105-1 through 105-M), and may generate, identify, etc. one or more respective outputs 301 for each input 105. For example, DAS 101 may generate a first output 301-1 based on input 105-1, a second output 301-2, and so on). DAS 101 may, for example, utilize LLMs and/or other AI/ML models to generate outputs 301 for respective inputs 105. In some embodiments, such LLMs, AI/ML models, etc. may be non-deterministic models and/or may otherwise not be based on output tuning parameters 109. In this manner, output 301 may range widely in terms of content and/or format.

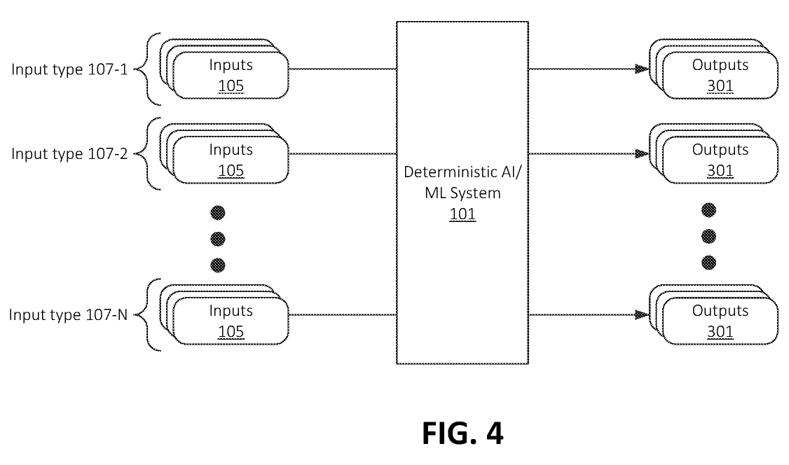

While FIG. 3 shows an example set of outputs 301 (e.g., outputs 301-1 through 301-M) being generated based on inputs 105 (e.g., inputs 105-1 through 105-M) for a particular input type 107-2, some or all of these operations may be performed (e.g., in parallel or otherwise) to identify or generate multiple sets of outputs 301 for multiple respective input types 107. For example, as shown in FIG. 4, multiple respective sets of outputs 301 may be generated for multiple different sets of input 105 that have each been classified as being associated with a respective input type 107.

Additionally, while FIG. 3 shows each output 301 as being generated based on one input 105, similar techniques described herein may apply in embodiments where DAS 101 generates multiple outputs 301 based on a given input 105. For example, DAS 101 may perform multiple iterations of a procedure in which one or more AI/ML models (e.g., LLMs) are used to generate outputs 301 for a given input 105. Since such AI/ML models may have an element of randomness or non-determinism, the outputs 301 for the same input 105 may vary widely.

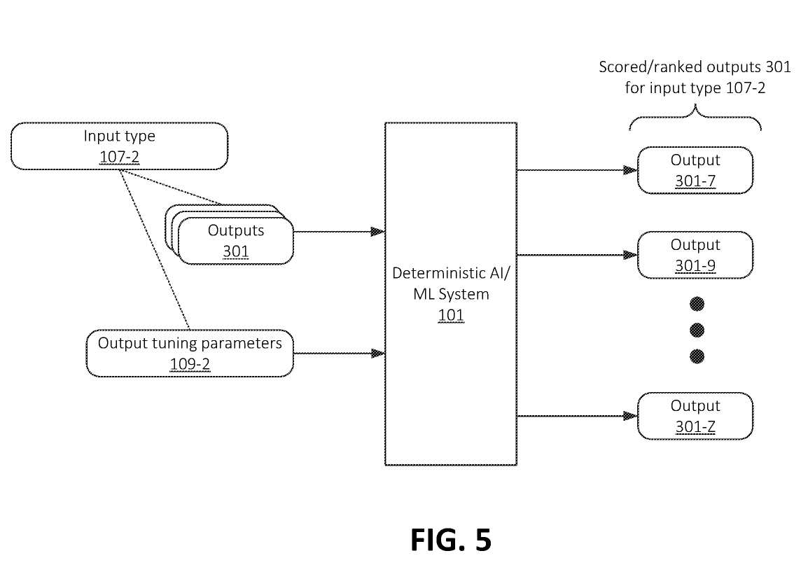

As shown in FIG. 5, DAS 101 may, in accordance with some embodiments, score and/or rank outputs 301, for a particular input type 107 (e.g., input type 107-2) based on output tuning parameters 109 associated with such input type 107 (e.g., output tuning parameters 109-2, in this example). For example, for a given output 301, DAS 101 may compare attributes or characteristics of such output 301 to parameters, constraints, rules, policies, formats, etc. specified in output tuning parameters 109 for a given input type 107. In one example, assume that a set of output tuning parameters 109 (e.g., output tuning parameters 109-2) includes parameters, characteristics, etc. applicable to outputs 301 generated based on applying one or more LLMs. In this example, scoring a given output 301 based on output tuning parameters 109-2 may include determining one or more scores (e.g., sub-scores) for output 301 based on one or more factors.

In some embodiments, such factors may include a measure of adherence to rules, policies, formats, etc. specified in output tuning parameters 109. In some embodiments, such factors may include a relevance score, which may reflect a measure of relevance of a given output 301 to an associated input 105. For example, assume that input 105 includes a question regarding a particular topic, and a first output 301 includes a response that includes information associated with the particular topic, while a second output 301 includes a response that does not include information associated with the particular topic. In some examples, the first output 301 may, in this situation, be associated with a higher relevance score with respect to input 105 than the second output 301. In some embodiments, the one or more factors may include one or more other factors, such as completeness, linguistic quality, or the like. In this manner, outputs 301 may be evaluated on the basis of quality, completeness, responsiveness, and/or relevance to a given input 105, while also being evaluated on the basis of whether such outputs 301 adhere to rules, policies, constraints, etc. specified in output tuning parameters 109 for a given input type 107.

In the example of FIG. 4, output 301-7 has been determined by DAS 101 has having a highest score (e.g., which may be based on combining, aggregating, etc. the sub-scores discussed above), out of outputs 301 that are associated with input type 107-2. Further in this example, output 301-9 has been determined as having a second highest score with respect to input type 107-2 (e.g., based on output tuning parameters 109-2 and/or other factors), and so on.

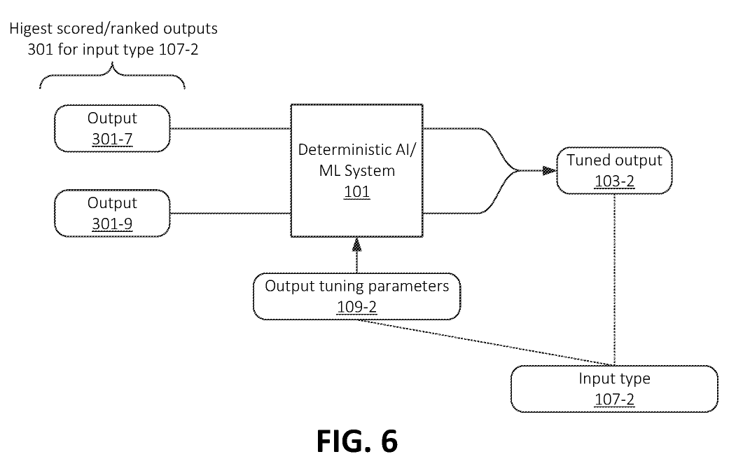

As shown in FIG. 6, the highest scored and/or ranked outputs 301 for a given input type 107 (e.g., input type 107-2, continuing with the above example) may be used to generate a particular tuned output 103 for input type 107. That is, out of a set of generated outputs 301 for the given input type 107, a particular subset of outputs 301 (e.g., outputs 301-7 and 301-9, in this example) may be selected or identified as tuned output 103.

For example, DAS 101 may generate or identify tuned output 103-2 for input type 107-2 based on one or more outputs 301 that were scored and/or ranked with respect to output tuning parameters 109-2. In this example, the highest two scoring outputs 301 (i.e., outputs 301-7 and 301-9, in this example) have been selected by DAS 101. In other example embodiments, additional outputs 301 may be selected, and/or only a single output 301 (e.g., the highest scoring output 301) may be selected. In some embodiments, DAS 101 may select outputs 301 that are associated with at least a threshold score (e.g., where such score is determined based on adherence to output tuning parameters 109-2, as discussed above), and/or may forgo selecting outputs 301 that are associated with scores that are below the threshold score.

For example, in some embodiments, DAS 101 may utilize one or more AI/ML techniques (e.g., NLP techniques, LLM techniques, etc.) to combine outputs 301-7 and 301-9 to generate tuned output 103-2. Additionally, or alternatively, DAS 101 may provide outputs 301-7 and 301-9 as input to an LLM or other type of AI/ML model that generates tuned output 103-2. For example, in some embodiments, tuned output 103-2 may be generated based on the highest scoring output (or outputs) 301 for input type 107-2, where such scoring is based on output tuning parameters 109-2. In some embodiments, DAS 101 may further utilize output tuning parameters 109-2 when generating tuned output 103-2. For example, in some embodiments, DAS 101 may utilize output 301-7, output 301-9, and output tuning parameters 109-2 when generating tuned output 103-2. Utilizing output tuning parameters 109-2 as input in such a manner may include, for example, modifying portions of outputs 301-7 and/or 301-9 to increase a measure of adherence to attributes, characteristics, constraints, etc. specified in output tuning parameters 109-2 (e.g., increase relative to outputs 301-7 and/or 301-9). Additionally, or alternatively, DAS 101 may modify portions of outputs 301-7 and/or output 301-9, when generating tuned output 103-2, to increase a measure of linguistic quality, relevance, completeness, etc. As another example, DAS 101 may maintain information associating both outputs 301-7 and 301-9 with input type 107-2, and may select output 301-7 or output 301-9 when generating tuned output 103-2 (e.g., may generate tuned output 103-2 based on output 301-7 or output 301-9, and/or may select output 301-7 or output 301-9 as tuned output 103-2).

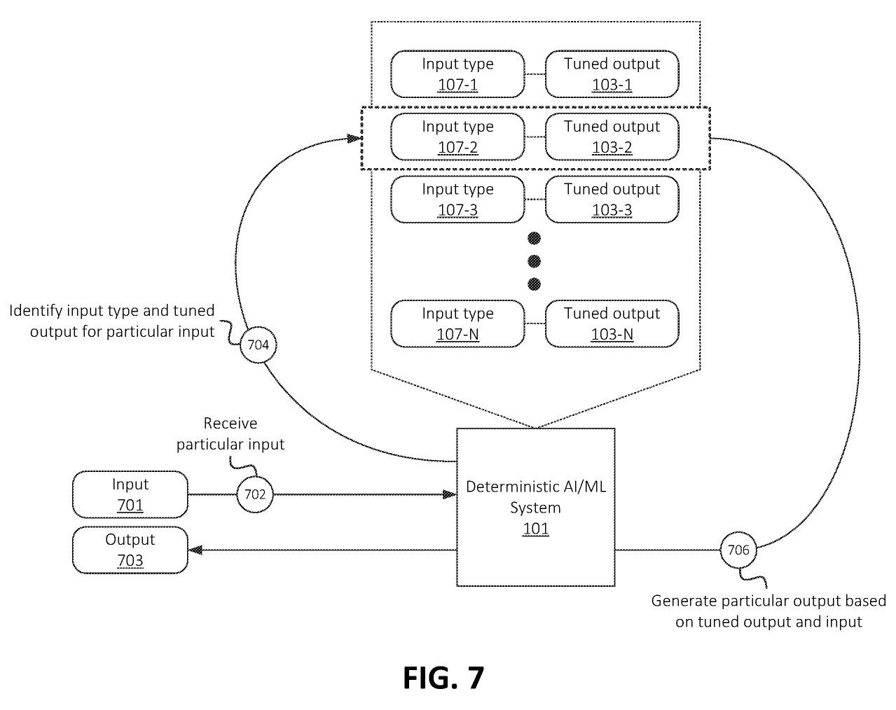

FIG. 7 illustrates an example scenario in which one or more techniques described above may be utilized in order to provide a deterministic output in response to a given input. As shown, for instance, DAS 101 may receive (at 702) a particular input 701. As similarly discussed above, in one example embodiment, input 701 may include a user-generated query, statement, or other text, such as a search query, a question regarding a user account or subscription, an instruction to control an Internet of Things ("IoT") device such as a smart home device, etc. As another example, input 701 may include a programmatically or automatically generated request, instruction, or other type of input, such as a request to provide optimal network configuration parameters based on a given set of network conditions, Key Performance Indicators ("KPIs"), network locations, etc.

DAS 101 may identify (at 704) a particular input type 107 with which input 701 is associated. For example, as discussed above, DAS 101 may identify attributes, characteristics, etc. of input 701, such as a content of input 701 (e.g., which may include words, phrases, commands, etc. included in input 701), a source of input 701 (e.g., a particular device or system from which input 701 was received), temporal aspects of input 701 (e.g., a time of day at which input 701 was received, a day of week at which input 701 was received, etc.). In this example, DAS 101 may identify that input 701 is associated with (e.g., matches, is similar to, is classified as, etc.) input type 107-2. As noted above, DAS 101 may have performed a training or learning operation in which input type 107-2 has been associated with tuned output 103-2.

Tuned output 103-2 may, in some embodiments, include a response template or format, in which DAS 101 may populate or provide additional variables, information, etc. not included in tuned output 103-2 itself. As one simplistic example, assume that a particular tuned output 103-2 includes a network parameter adjustment, such as an adjustment of an azimuth angle of a wireless antenna (e.g., adding or subtracting to an arbitrary current azimuth angle). DAS 101 may generate (at 706) output 703 in response to input 701, where output 703 is based on tuned output 103-2. For example, output 703 may include an absolute value for an azimuth angle of the wireless antenna, which may be based on the adjustment specified in tuned output 103-2, and may further be based on information not provided or included in tuned output 103-2 (e.g., may be based on the current azimuth angle of the wireless antenna, which may be determined by DAS 101 based on information received from a network management system or other suitable information source). In this example, output 703 may include a new azimuth angle (e.g., an absolute value, as opposed to a relative value), which may be useful for communicating with systems that are configured to receive absolute values rather than incremental adjustments). That is, in some embodiments, output 703 (generated in response to input 701) may be structured, formatted, etc. based on tuned output 103-2, and may further be populated with information not included in tuned output 103-2. On the other hand, in some embodiments, providing output 703 (generated in response to input 701) may include forwarding tuned output 103-2 "as is" (e.g., without further modification). As noted above, since tuned output 103-2 has been tuned, refined, generated, etc. based on a particular set of output tuning parameters 109-2 that has been associated with input type 107-2, output 703 (generated based on tuned output 103-2) may conform to preferences, settings, formats, etc. that are appropriate or optimal for input type 107-2, and that are further deterministic and/or predictable (e.g., inasmuch as it is predictable that output 703 will adhere to such preferences, settings, formats, etc.).

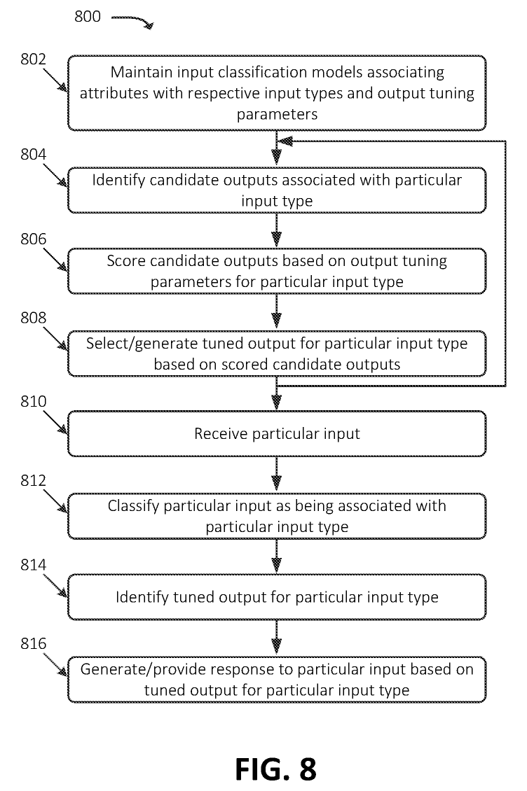

FIG. 8 illustrates an example process 800 for providing tuned outputs in response to input such as user-generated queries or prompts, network configuration requests, or other types of inputs. In some embodiments, some or all of process 800 may be performed by DAS 101. In some embodiments, one or more other devices may perform some or all of process 800 in concert with, and/or in lieu of, DAS 101.

As shown, process 800 may include maintaining (at 802) a set of input classification models that associate particular sets of attributes with respective input types. For example, as discussed above, DAS 101 may generate, refine, train, etc. one or more input classification models 201 based on various attributes, such as words or phrases, an indication of a particular user or device, a time of day, a geographical location, an identifier of one or more network devices, and/or other suitable characteristics or attributes. As discussed above, a particular input type 107 may be associated with a particular set of attributes, as well as a set of output tuning parameters 109 which may be used to ultimately identify a representative output or set of outputs (e.g., tuned outputs 103) with which input type 107 is associated.

Process 800 may additionally include identifying (at 804) a set of candidate outputs associated with the particular input type. For example, DAS 101 may generate, receive, classify, etc. one or more inputs (e.g., requests, queries, statements, prompts, etc.) and may identify or generate multiple outputs (e.g., responses) based on the one or more inputs. DAS 101 may, for example, utilize LLMs or other types of AI/ML techniques to generate or identify the multiple outputs. As noted above, the outputs may be widely varied (e.g., in terms of content, format, accuracy, etc.), due to the configuration or training of respective models or techniques based on which the outputs are generated.

Process 800 may also include scoring (at 806) the candidate outputs based on the particular output tuning parameters 109 for the particular input type 107. For example, DAS 101 may identify a measure of adherence, similarity, etc. between each candidate output and attributes of the particular set of output tuning parameters 109 (e.g., rules, policies, templates, constraints, etc. specified in the particular set of output tuning parameters 109). In some embodiments, scoring the candidate outputs may further include scoring or evaluating the candidate outputs on other factors that are not dependent on (or otherwise based on) output tuning parameters 109, such as a measure of linguistic quality, a measure of completeness and/or accuracy, and/or other suitable factors.

Process 800 may further include selecting or generating (at 808) a particular tuned output 103 for the particular input type 107 based on the scoring. For example, as discussed above, DAS 101 may select a highest scoring candidate output as the particular tuned output 103 for the particular input type 107. Additionally, or alternatively, DAS 101 may select multiple candidate outputs, such as the highest x scoring candidate outputs (e.g., where x is a predetermined quantity). Additionally, or alternatively, DAS 101 may select multiple candidate outputs, such as candidate outputs with at least a threshold score (e.g., based on the scoring at 808). In some embodiments, DAS 101 may combine, aggregate, etc. multiple of the selected candidate outputs to generate tuned output 103. In some embodiments, when combining, aggregating, etc. multiple candidate outputs to generate tuned output 103, DAS 101 may utilize some or all of the parameters, characteristics, etc. of output tuning parameters 109 to ensure that tuned output 103 meets such parameters, characteristics, etc. For example, in some scenarios, tuned output 103 may be associated with a higher score than some or all of the candidate outputs based on which tuned output 103 is generated.

Process 800 may further include receiving (at 810) a particular input. For example, DAS 101 may receive a user-generated query or prompt, a programmatically generated request or other type of input, etc.

Process 800 may additionally include classifying (at 812) the particular received input as being associated with a particular input type 107. For example, DAS 101 may utilize one or more input classification models 201 to determine that the particular input is associated with a particular input type 107, such as by comparing attributes, characteristics, features, etc. of the received input to attributes, characteristics, features, etc. specified in the input classification models 201 as being associated with one or more candidate input types 107. Such comparing may include performing a similarity analysis or other suitable type of analysis to determine that the attributes, characteristics, etc. of the received input match, meet, etc. (e.g., with at least a threshold measure of similarity) the attributes, characteristics, etc. of the particular input type 107.

Process 800 may also include identifying (at 814) the respective tuned output 103 for the identified input type 107. For example, as discussed above, DAS 101 may have generated, identified, etc. tuned output 103 for input type 107. Process 800 may further include generating and providing (at 816) a response to the particular input based on the particular tuned output 103 for the identified input type 107. For example, as discussed above, DAS 101 may provide the particular tuned output 103 itself as a response to the input (received at 810). In some embodiments, DAS 101 may generate a response that is based on the particular tuned output 103, and that includes additional information (e.g., DAS 101 may receive or obtain additional information that is not included in tuned output 103, and populate such information in the generated response). As discussed above, tailoring the response to particular formats, constraints, rules, policies, etc. (e.g., as indicated or specified by a respective set of output tuning parameters 109 associated with a particular input type 107 with which the received input is identified as being associated) may ensure that such responses are optimal, inasmuch as such responses adhere to such formats, constraints, rules, policies, etc.

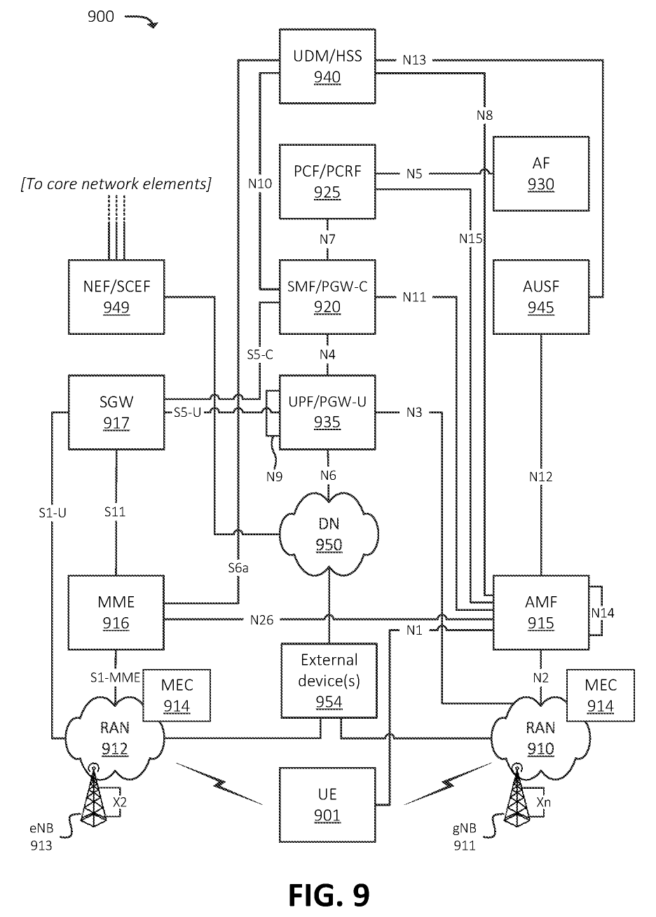

FIG. 9 illustrates an example environment 900, in which one or more embodiments may be implemented. In some embodiments, environment 900 may correspond to a Fifth Generation ("5G") network, and/or may include elements of a 5G network. In some embodiments, environment 900 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 900 may represent or may include a 5G core ("5GC"). As shown, environment 900 may include UE 901, RAN 910 (which may include one or more Next Generation Node Bs ("gNBs") 911), RAN 912 (which may include one or more evolved Node Bs ("eNBs") 913), and various network functions such as Access and Mobility Management Function ("AMF") 915, Mobility Management Entity ("MME") 916, Serving Gateway ("SGW") 917, Session Management Function ("SMF")/Packet Data Network ("PDN") Gateway ("PGW")-Control plane function ("PGW-C") 920, Policy Control Function ("PCF")/Policy Charging and Rules Function ("PCRF") 925, Application Function ("AF") 930, User Plane Function ("UPF")/PGW-User plane function ("PGW-U") 935, Unified Data Management ("UDM")/Home Subscriber Server ("HSS") 940, Authentication Server Function ("AUSF") 945, and Network Exposure Function ("NEF")/Service Capability Exposure Function ("SCEF") 949. Environment 900 may also include one or more networks, such as Data Network ("DN") 950. Environment 900 may include one or more additional devices or systems communicatively coupled to one or more networks (e.g., DN 950), such as one or more external devices 954.

The example shown in FIG. 9 illustrates one instance of each network component or function (e.g., one instance of SMF/PGW-C 920, PCF/PCRF 925, UPF/PGW-U 935, UDM/HSS 940, and/or AUSF 945). In practice, environment 900 may include multiple instances of such components or functions. For example, in some embodiments, environment 900 may include multiple "slices" of a core network, where each slice includes a discrete and/or logical set of network functions (e.g., one slice may include a first instance of AMF 915, SMF/PGW-C 920, PCF/PCRF 925, and/or UPF/PGW-U 935, while another slice may include a second instance of AMF 915, SMF/PGW-C 920, PCF/PCRF 925, and/or UPF/PGW-U 935). The different slices may provide differentiated levels of service, such as service in accordance with different Quality of Service ("QoS") parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Additionally, one or more elements of environment 900 may be implemented in a virtualized and/or containerized manner. For example, one or more of the elements of environment 900 may be implemented by one or more Virtualized Network Functions ("VNFs"), Cloud-Native Network Functions ("CNFs"), etc. In such embodiments, environment 900 may include, may implement, and/or may be communicatively coupled to an orchestration platform that provisions hardware resources, installs containers or applications, performs load balancing, and/or otherwise manages the deployment of such elements of environment 900. In some embodiments, such orchestration and/or management of such elements of environment 900 may be performed by, or in conjunction with, the open-source Kubernetes^{®} application programming interface ("API") or some other suitable virtualization, containerization, and/or orchestration system.

Elements of environment 900 may interconnect with each other and/or other devices via wired connections, wireless connections, or a combination of wired and wireless connections. Examples of interfaces or communication pathways between the elements of environment 900, as shown in FIG. 9, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 9, such as Service-Based Interfaces ("SBIs"), including an Namf interface, an Nudm interface, an Npcf interface, an Nupf interface, an Nnef interface, an Nsmf interface, and/or one or more other SBIs.

UE 901 may include a computation and communication device, such as a wireless mobile communication device that is capable of communicating with RAN 910, RAN 912, and/or DN 950. UE 901 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 901 may send traffic to and/or receive traffic (e.g., user plane traffic) from DN 950 via RAN 910, RAN 912, and/or UPF/PGW-U 935.

RAN 910 may be, or may include, a 5G RAN that implements a 5G RAT and that includes one or more base stations (e.g., one or more gNBs 911), via which UE 901 may communicate with one or more other elements of environment 900. UE 901 may communicate with RAN 910 via an air interface (e.g., as provided by gNB 911). For instance, RAN 910 may receive traffic (e.g., user plane traffic such as voice call traffic, data traffic, messaging traffic, etc.) from UE 901 via the air interface, and may communicate the traffic to UPF/PGW-U 935 and/or one or more other devices or networks. Further, RAN 910 may receive signaling traffic, control plane traffic, etc. from UE 901 via the air interface, and may communicate such signaling traffic, control plane traffic, etc. to AMF 915 and/or one or more other devices or networks. Additionally, RAN 910 may receive traffic intended for UE 901 (e.g., from UPF/PGW-U 935, AMF 915, and/or one or more other devices or networks) and may communicate the traffic to UE 901 via the air interface.

RAN 912 may be, or may include, an LTE RAN that implements an LTE RAT and that includes one or more base stations (e.g., one or more eNBs 913), via which UE 901 may communicate with one or more other elements of environment 900. UE 901 may communicate with RAN 912 via an air interface (e.g., as provided by eNB 913). For instance, RAN 912 may receive traffic (e.g., user plane traffic such as voice call traffic, data traffic, messaging traffic, signaling traffic, etc.) from UE 901 via the air interface, and may communicate the traffic to UPF/PGW-U 935 (e.g., via SGW 917) and/or one or more other devices or networks. Further, RAN 912 may receive signaling traffic, control plane traffic, etc. from UE 901 via the air interface, and may communicate such signaling traffic, control plane traffic, etc. to MME 916 and/or one or more other devices or networks. Additionally, RAN 912 may receive traffic intended for UE 901 (e.g., from UPF/PGW-U 935, MME 916, SGW 917, and/or one or more other devices or networks) and may communicate the traffic to UE 901 via the air interface.

One or more RANs of environment 900 (e.g., RAN 910 and/or RAN 912) may include, may implement, and/or may otherwise be communicatively coupled to one or more edge computing devices, such as one or more Multi-Access/Mobile Edge Computing ("MEC") devices (referred to sometimes herein simply as a "MECs") 914. MECs 914 may be co-located with wireless network infrastructure equipment of RANs 910 and/or 912 (e.g., one or more gNBs 911 and/or one or more eNBs 913, respectively). Additionally, or alternatively, MECs 914 may otherwise be associated with geographical regions (e.g., coverage areas) of wireless network infrastructure equipment of RANs 910 and/or 912. In some embodiments, one or more MECs 914 may be implemented by the same set of hardware resources, the same set of devices, etc. that implement wireless network infrastructure equipment of RANs 910 and/or 912. In some embodiments, one or more MECs 914 may be implemented by different hardware resources, a different set of devices, etc. from hardware resources or devices that implement wireless network infrastructure equipment of RANs 910 and/or 912. In some embodiments, MECs 914 may be communicatively coupled to wireless network infrastructure equipment of RANs 910 and/or 912 (e.g., via a high-speed and/or low-latency link such as a physical wired interface, a high-speed and/or low-latency wireless interface, or some other suitable communication pathway).

MECs 914 may include hardware resources (e.g., configurable or provisionable hardware resources) that may be configured to provide services and/or otherwise process traffic to and/or from UE 901, via RAN 910 and/or 912. For example, RAN 910 and/or 912 may route some traffic from UE 901 (e.g., traffic associated with one or more particular services, applications, application types, etc.) to a respective MEC 914 instead of to core network elements of 900 (e.g., UPF/PGW-U 935). MEC 914 may accordingly provide services to UE 901 by processing such traffic, performing one or more computations based on the received traffic, and providing traffic to UE 901 via RAN 910 and/or 912. MEC 914 may include, and/or may implement, some or all of the functionality described above with respect to UPF/PGW-U 935, AF 930, one or more application servers, and/or one or more other devices, systems, VNFs, CNFs, etc. In this manner, ultra-low latency services may be provided to UE 901, as traffic does not need to traverse links (e.g., backhaul links) between RAN 910 and/or 912 and the core network.

AMF 915 may include one or more devices, systems, VNFs, CNFs, etc., that perform operations to register UE 901 with the 5G network, to establish bearer channels associated with a session with UE 901, to hand off UE 901 from the 5G network to another network, to hand off UE 901 from the other network to the 5G network, manage mobility of UE 901 between RANs 910 and/or gNBs 911, and/or to perform other operations. In some embodiments, the 5G network may include multiple AMFs 915, which communicate with each other via the N14 interface (denoted in FIG. 9 by the line marked "N14" originating and terminating at AMF 915).

MME 916 may include one or more devices, systems, VNFs, CNFs, etc., that perform operations to register UE 901 with the EPC, to establish bearer channels associated with a session with UE 901, to hand off UE 901 from the EPC to another network, to hand off UE 901 from another network to the EPC, manage mobility of UE 901 between RANs 912 and/or eNBs 913, and/or to perform other operations.

SGW 917 may include one or more devices, systems, VNFs, CNFs, etc., that aggregate traffic received from one or more eNBs 913 and send the aggregated traffic to an external network or device via UPF/PGW-U 935. Additionally, SGW 917 may aggregate traffic received from one or more UPF/PGW-Us 935 and may send the aggregated traffic to one or more eNBs 913. SGW 917 may operate as an anchor for the user plane during inter-eNB handovers and as an anchor for mobility between different telecommunication networks or RANs (e.g., RANs 910 and 912).

SMF/PGW-C 920 may include one or more devices, systems, VNFs, CNFs, etc., that gather, process, store, and/or provide information in a manner described herein. SMF/PGW-C 920 may, for example, facilitate the establishment of communication sessions on behalf of UE 901. In some embodiments, the establishment of communications sessions may be performed in accordance with one or more policies provided by PCF/PCRF 925.

PCF/PCRF 925 may include one or more devices, systems, VNFs, CNFs, etc., that aggregate information to and from the 5G network and/or other sources. PCF/PCRF 925 may receive information regarding policies and/or subscriptions from one or more sources, such as subscriber databases and/or from one or more users (such as, for example, an administrator associated with PCF/PCRF 925).

AF 930 may include one or more devices, systems, VNFs, CNFs, etc., that receive, store, and/or provide information that may be used in determining parameters (e.g., quality of service parameters, charging parameters, or the like) for certain applications.

UPF/PGW-U 935 may include one or more devices, systems, VNFs, CNFs, etc., that receive, store, and/or provide data (e.g., user plane data). For example, UPF/PGW-U 935 may receive user plane data (e.g., voice call traffic, data traffic, etc.), destined for UE 901, from DN 950, and may forward the user plane data toward UE 901 (e.g., via RAN 910, SMF/PGW-C 920, and/or one or more other devices). In some embodiments, multiple instances of UPF/PGW-U 935 may be deployed (e.g., in different geographical locations), and the delivery of content to UE 901 may be coordinated via the N9 interface (e.g., as denoted in FIG. 9 by the line marked "N9" originating and terminating at UPF/PGW-U 935). Similarly, UPF/PGW-U 935 may receive traffic from UE 901 (e.g., via RAN 910, RAN 912, SMF/PGW-C 920, and/or one or more other devices), and may forward the traffic toward DN 950. In some embodiments, UPF/PGW-U 935 may communicate (e.g., via the N4 interface) with SMF/PGW-C 920, regarding user plane data processed by UPF/PGW-U 935.

UDM/HSS 940 and AUSF 945 may include one or more devices, systems, VNFs, CNFs, etc., that manage, update, and/or store, in one or more memory devices associated with AUSF 945 and/or UDM/HSS 940, profile information associated with a subscriber. In some embodiments, UDM/HSS 940 may include, may implement, may be communicatively coupled to, and/or may otherwise be associated with some other type of repository or database, such as a Unified Data Repository ("UDR"). AUSF 945 and/or UDM/HSS 940 may perform authentication, authorization, and/or accounting operations associated with one or more UEs 901 and/or one or more communication sessions associated with one or more UEs 901.

DN 950 may include one or more wired and/or wireless networks. For example, DN 950 may include an Internet Protocol ("IP")-based PDN, a wide area network ("WAN") such as the Internet, a private enterprise network, and/or one or more other networks. UE 901 may communicate, through DN 950, with data servers, other UEs 901, and/or to other servers or applications that are coupled to DN 950. DN 950 may be connected to one or more other networks, such as a public switched telephone network ("PSTN"), a public land mobile network ("PLMN"), and/or another network. DN 950 may be connected to one or more devices, such as content providers, applications, web servers, and/or other devices, with which UE 901 may communicate.

External devices 954 may include one or more devices or systems that communicate with UE 901 via DN 950 and one or more elements of 900 (e.g., via UPF/PGW-U 935). In some embodiments, external devices 954 may include, may implement, and/or may otherwise be associated with DAS 101. External devices 954 may include, for example, one or more application servers, content provider systems, web servers, or the like. External devices 954 may, for example, implement "server-side" applications that communicate with "client-side" applications executed by UE 901. External devices 954 may provide services to UE 901 such as gaming services, videoconferencing services, messaging services, email services, web services, and/or other types of services. Operations described above with respect to a given external device 954 (e.g., in accordance with some embodiments) may be performed by a single device, by a cloud computing system, by one or more devices that implement a virtualized or containerized environment, a collection of devices, etc.

In some embodiments, external devices 954 may communicate with one or more elements of environment 900 (e.g., core network elements) via NEF/SCEF 949. NEF/SCEF 949 include one or more devices, systems, VNFs, CNFs, etc. that provide access to information, APIs, and/or other operations or mechanisms of one or more core network elements to devices or systems that are external to the core network (e.g., to external device 954 via DN 950). NEF/SCEF 949 may maintain authorization and/or authentication information associated with such external devices or systems, such that NEF/SCEF 949 is able to provide information, that is authorized to be provided, to the external devices or systems. For example, a given external device 954 may request particular information associated with one or more core network elements. NEF/SCEF 949 may authenticate the request and/or otherwise verify that external device 954 is authorized to receive the information, and may request, obtain, or otherwise receive the information from the one or more core network elements. In some embodiments, NEF/SCEF 949 may include, may implement, may be implemented by, may be communicatively coupled to, and/or may otherwise be associated with a Security Edge Protection Proxy ("SEPP"), which may perform some or all of the functions discussed above. External device 954 may, in some situations, subscribe to particular types of requested information provided by the one or more core network elements, and the one or more core network elements may provide (e.g., "push") the requested information to NEF/SCEF 949 (e.g., in a periodic or otherwise ongoing basis).

In some embodiments, external devices 954 may communicate with one or more elements of RAN 910 and/or 912 via an API or other suitable interface. For example, a given external device 954 may provide instructions, requests, etc. to RAN 910 and/or 912 to provide one or more services via one or more respective MECs 914. In some embodiments, such instructions, requests, etc. may include QoS parameters, Service Level Agreements ("SLAs"), etc. (e.g., maximum latency thresholds, minimum throughput thresholds, etc.) associated with the services.

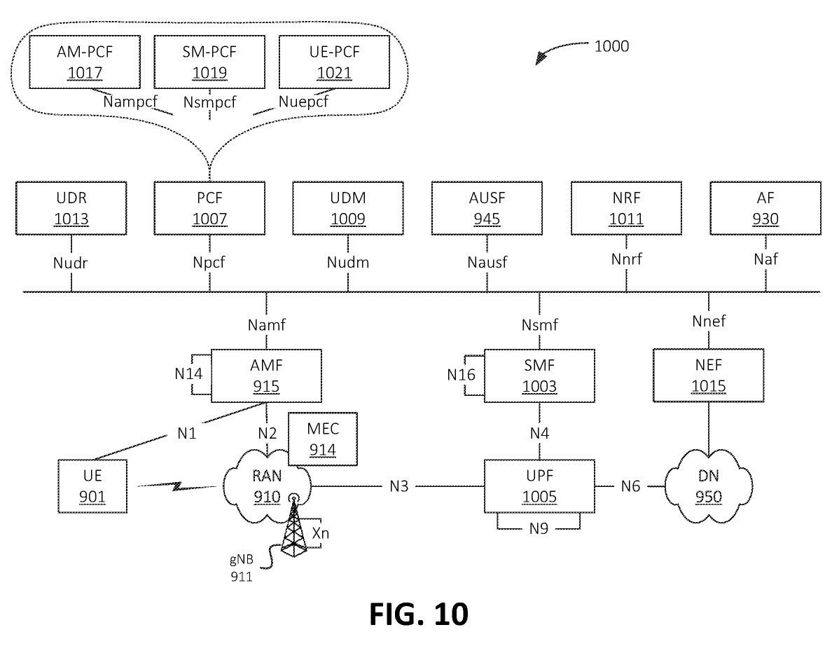

FIG. 10 illustrates another example environment 1000, in which one or more embodiments may be implemented. In some embodiments, environment 1000 may correspond to a 5G network, and/or may include elements of a 5G network. In some embodiments, environment 1000 may correspond to a 5G SA architecture. In some embodiments, environment 1000 may include a 5GC, in which 5GC network elements perform one or more operations described herein.

As shown, environment 1000 may include UE 901, RAN 910 (which may include one or more gNBs 911 or other types of wireless network infrastructure) and various network functions, which may be implemented as VNFs, CNFs, etc. Such network functions may include AMF 915, SMF 1003, UPF 1005, PCF 1007, UDM 1009, AUSF 945, Network Repository Function ("NRF") 1011, AF 930, UDR 1013, and NEF 1015. Environment 1000 may also include or may be communicatively coupled to one or more networks, such as DN 950.

The example shown in FIG. 10 illustrates one instance of each network component or function (e.g., one instance of SMF 1003, UPF 1005, PCF 1007, UDM 1009, AUSF 945, etc.). In practice, environment 1000 may include multiple instances of such components or functions. For example, in some embodiments, environment 1000 may include multiple "slices" of a core network, where each slice includes a discrete and/or logical set of network functions (e.g., one slice may include a first instance of SMF 1003, PCF 1007, UPF 1005, etc., while another slice may include a second instance of SMF 1003, PCF 1007, UPF 1005, etc.). Additionally, or alternatively, one or more of the network functions of environment 1000 may implement multiple network slices. The different slices may provide differentiated levels of service, such as service in accordance with different QoS parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. In some implementations, one or more devices of environment 1000 may be physically integrated in, and/or may be physically attached to, one or more other devices of environment 1000. Alternatively, or additionally, one or more of the devices of environment 1000 may perform one or more network functions described as being performed by another one or more of the devices of environment 1000.

Elements of environment 1000 may interconnect with each other and/or other devices via wired connections, wireless connections, or a combination of wired and wireless connections. Examples of interfaces or communication pathways between the elements of environment 1000, as shown in FIG. 10, may include interfaces shown in FIG. 10 and/or one or more interfaces not explicitly shown in FIG. 10. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1000 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 915), an Nudm interface (e.g., indicating communications to be routed to UDM 1009), an Npcf interface, an Nupf interface, an Nnef interface, an Nsmf interface, an Nnrf interface, an Nudr interface, an Naf interface, and/or one or more other SBIs.

UPF 1005 may include one or more devices, systems, VNFs, CNFs, etc., that receive, route, process, and/or forward traffic (e.g., user plane traffic). As discussed above, UPF 1005 may communicate with UE 901 via one or more communication sessions, such as PDU sessions. Such PDU sessions may be associated with a particular network slice or other suitable QoS parameters, as noted above. UPF 1005 may receive downlink user plane traffic (e.g., voice call traffic, data traffic, etc. destined for UE 901) from DN 950, and may forward the downlink user plane traffic toward UE 901 (e.g., via RAN 910). In some embodiments, multiple UPFs 1005 may be deployed (e.g., in different geographical locations), and the delivery of content to UE 901 may be coordinated via the N9 interface. Similarly, UPF 1005 may receive uplink traffic from UE 901 (e.g., via RAN 910), and may forward the traffic toward DN 950. In some embodiments, UPF 1005 may implement, may be implemented by, may be communicatively coupled to, and/or may otherwise be associated with UPF/PGW-U 935. In some embodiments, UPF 1005 may communicate (e.g., via the N4 interface) with SMF 1003, regarding user plane data processed by UPF 1005 (e.g., to provide analytics or reporting information, to receive policy and/or authorization information, etc.).

PCF 1007 may include one or more devices, systems, VNFs, CNFs, etc., that aggregate, derive, generate, etc. policy information associated with the 5GC and/or UEs 901 that communicate via the 5GC and/or RAN 910. PCF 1007 may receive information regarding policies and/or subscriptions from one or more sources, such as subscriber databases (e.g., UDM 1009, UDR 1013, etc.), and/or from one or more users such as, for example, an administrator associated with PCF 1007. In some embodiments, the functionality of PCF 1007 may be split into multiple network functions or subsystems, such as access and mobility PCF ("AM-PCF") 1017, session management PCF ("SM-PCF") 1019, UE PCF ("UE-PCF") 1021, and so on. Such different "split" PCFs may be associated with respective SBIs (e.g., AM-PCF 1017 may be associated with an Nampcf SBI, SM-PCF 1019 may be associated with an Nsmpcf SBI, UE-PCF 1021 may be associated with an Nuepcf SBI, and so on) via which other network functions may communicate with the split PCFs. The split PCFs may maintain information regarding policies associated with different devices, systems, and/or network functions.

NRF 1011 may include one or more devices, systems, VNFs, CNFs, etc. that maintain routing and/or network topology information associated with the 5GC. For example, NRF 1011 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1013 may include one or more devices, systems, VNFs, CNFs, etc. that provide user and/or subscriber information, based on which PCF 1007 and/or other elements of environment 1000 may determine access policies, QoS policies, charging policies, or the like. In some embodiments, UDR 1013 may receive such information from UDM 1009 and/or one or more other sources.

NEF 1015 include one or more devices, systems, VNFs, CNFs, etc. that provide access to information, APIs, and/or other operations or mechanisms of the 5GC to devices or systems that are external to the 5GC. NEF 1015 may maintain authorization and/or authentication information associated with such external devices or systems, such that NEF 1015 is able to provide information, that is authorized to be provided, to the external devices or systems. Such information may be received from other network functions of the 5GC (e.g., as authorized by an administrator or other suitable entity associated with the 5GC), such as SMF 1003, UPF 1005, a charging function ("CHF") of the 5GC, and/or other suitable network function. NEF 1015 may communicate with external devices or systems (e.g., external devices 954) via DN 950 and/or other suitable communication pathways.

While environment 1000 is described in the context of a 5GC, as noted above, environment 1000 may, in some embodiments, include or implement one or more other types of core networks. For example, in some embodiments, environment 1000 may be or may include a converged packet core, in which one or more elements may perform some or all of the functionality of one or more 5GC network functions and/or one or more EPC network functions. For example, in some embodiments, AMF 915 may include, may implement, may be implemented by, and/or may otherwise be associated with MME 916; SMF 1003 may include, may implement, may be implemented by, and/or may otherwise be associated with SGW 917; PCF 1007 may include, may implement, may be implemented by, and/or may otherwise be associated with a PCRF (e.g., PCF/PCRF 925); NEF 1015 may include, may implement, may be implemented by, and/or may otherwise be associated with a SCEF (e.g., NEF/SCEF 949); and so on.

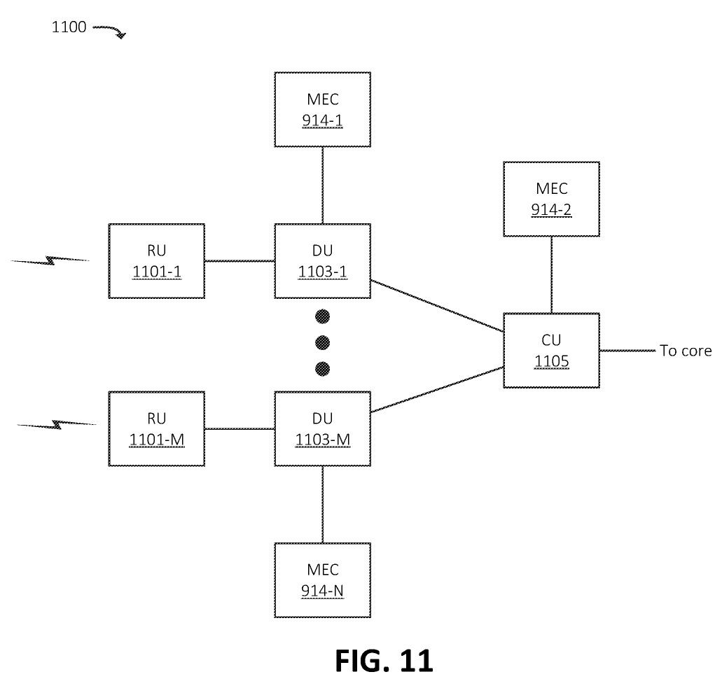

FIG. 11 illustrates an example RAN environment 1100, which may be included in and/or implemented by one or more RANs (e.g., RAN 910 or some other RAN). In some embodiments, a particular RAN 910 may include one RAN environment 1100. In some embodiments, a particular RAN 910 may include multiple RAN environments 1100. In some embodiments, RAN environment 1100 may correspond to a particular gNB 911 of RAN 910. In some embodiments, RAN environment 1100 may correspond to multiple gNBs 911. In some embodiments, RAN environment 1100 may correspond to one or more other types of base stations of one or more other types of RANs. As shown, RAN environment 1100 may include Central Unit ("CU") 1105, one or more Distributed Units ("DUs") 1103-1 through 1103-M (referred to individually as "DU 1103," or collectively as "DUs 1103"), and one or more Radio Units ("RUs") 1101-1 through 1101-M (referred to individually as "RU 1101," or collectively as "RUs 1101").

CU 1105 may communicate with a core of a wireless network (e.g., may communicate with one or more of the devices or systems described above with respect to FIG. 10, such as AMF 915 and/or UPF 1005) and/or some other device or system such as MEC 914. In the uplink direction (e.g., for traffic from UEs 901 to a core network), CU 1105 may aggregate traffic from DUs 1103, and forward the aggregated traffic to the core network. In some embodiments, CU 1105 may receive traffic according to a given protocol (e.g., Radio Link Control ("RLC") traffic) from DUs 1103, and may perform higher-layer processing (e.g., may aggregate/process RLC packets and generate Packet Data Convergence Protocol ("PDCP") packets based on the RLC packets) on the traffic received from DUs 1103.

CU 1105 may receive downlink traffic (e.g., traffic from the core network, traffic from a given MEC 914, etc.) for a particular UE 901, and may determine which DU(s) 1103 should receive the downlink traffic. DU 1103 may include one or more devices that transmit traffic between a core network (e.g., via CU 1105) and UE 901 (e.g., via a respective RU 1101). DU 1103 may, for example, receive traffic from RU 1101 at a first layer (e.g., physical ("PHY") layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 901.

RU 1101 may include hardware circuitry (e.g., one or more RF transceivers, antennas, radios, and/or other suitable hardware) to communicate wirelessly (e.g., via an RF interface) with one or more UEs 901, one or more other DUs 1103 (e.g., via RUs 1101 associated with DUs 1103), and/or any other suitable type of device. In the uplink direction, RU 1101 may receive traffic from UE 901 and/or another DU 1103 via the RF interface and may provide the traffic to DU 1103. In the downlink direction, RU 1101 may receive traffic from DU 1103, and may provide the traffic to UE 901 and/or another DU 1103.

One or more elements of RAN environment 1100 may, in some embodiments, be communicatively coupled to one or more MECs 914. For example, DU 1103-1 may be communicatively coupled to MEC 914-1, DU 1103-M may be communicatively coupled to MEC 914-N, CU 1105 may be communicatively coupled to MEC 914-2, and so on. MECs 914 may include hardware resources (e.g., configurable or provisionable hardware resources) that may be configured to provide services and/or otherwise process traffic to and/or from UE 901, via a respective RU 1101.

For example, DU 1103-1 may route some traffic, from UE 901, to MEC 914-1 instead of to a core network via CU 1105. MEC 914-1 may process the traffic, perform one or more computations based on the received traffic, and may provide traffic to UE 901 via RU 1101-1. As discussed above, MEC 914 may include, and/or may implement, some or all of the functionality described above with respect to UPF 1005, AF 930, and/or one or more other devices, systems, VNFs, CNFs, etc. In this manner, ultra-low latency services may be provided to UE 901, as traffic does not need to traverse DU 1103, CU 1105, links between DU 1103 and CU 1105, and an intervening backhaul network between RAN environment 1100 and the core network.

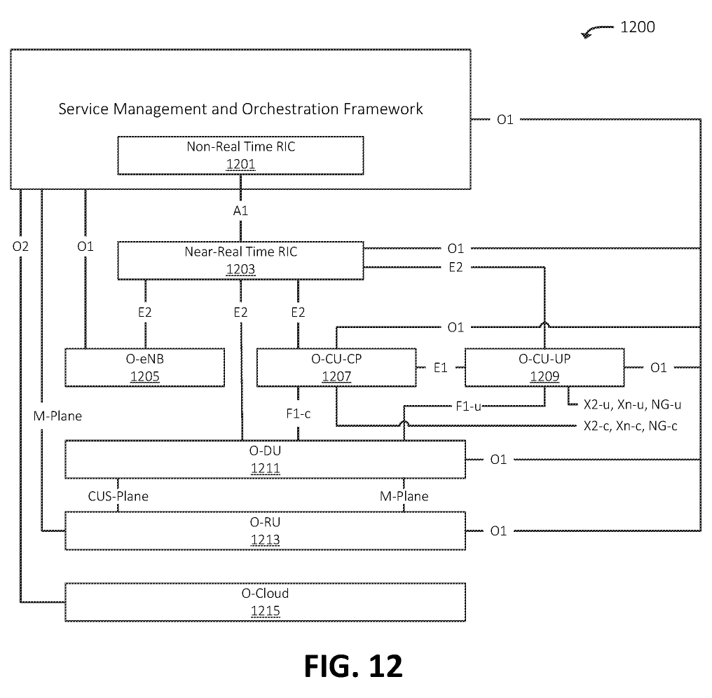

FIG. 12 illustrates an example O-RAN environment 1200, which may correspond to RAN 910, RAN 912, and/or RAN environment 1100. For example, RAN 910, RAN 912, and/or RAN environment 1100 may include one or more instances of O-RAN environment 1200, and/or one or more instances of O-RAN environment 1200 may implement RAN 910, RAN 912, RAN environment 1100, and/or some portion thereof. As shown, O-RAN environment 1200 may include Non-Real Time Radio Intelligent Controller ("RIC") 1201, Near-Real Time RIC 1203, O-eNB 1205, O-CU-Control Plane ("O-CU-CP") 1207, O-CU-User Plane ("O-CU-UP") 1209, O-DU 1211, O-RU 1213, and O-Cloud 1215. In some embodiments, O-RAN environment 1200 may include additional, fewer, different, and/or differently arranged components or interfaces.

In some embodiments, some or all of the elements of O-RAN environment 1200 may be implemented by one or more configurable or provisionable resources, such as virtual machines, cloud computing systems, physical servers, and/or other types of configurable or provisionable resources. In some embodiments, some or all of O-RAN environment 1200 may be implemented by, and/or communicatively coupled to, one or more MECs 914.

Non-Real Time RIC 1201 and Near-Real Time RIC 1203 may receive performance information (and/or other types of information) from one or more sources, and may configure other elements of O-RAN environment 1200 based on such performance or other information. For example, Near-Real Time RIC 1203 may receive performance information, via one or more E2 interfaces, from O-eNB 1205, O-CU-CP 1207, and/or O-CU-UP 1209, and may modify parameters associated with O-eNB 1205, O-CU-CP 1207, and/or O-CU-UP 1209 based on such performance information. Similarly, Non-Real Time RIC 1201 may receive performance information associated with O-eNB 1205, O-CU-CP 1207, O-CU-UP 1209, and/or one or more other elements of O-RAN environment 1200 and may utilize machine learning and/or other higher level computing or processing to determine modifications to the configuration of O-eNB 1205, O-CU-CP 1207, O-CU-UP 1209, and/or other elements of O-RAN environment 1200.

In some embodiments, Non-Real Time RIC 1201 may generate machine learning models based on performance information associated with O-RAN environment 1200 or other sources, and may provide such models to Near-Real Time RIC 1203 for implementation. For example, in some embodiments, Non-Real Time RIC 1201 and/or Near-Real Time RIC 1203 may perform some or all of the operations described above with respect to DAS 101, and/or DAS 101 may perform some or all of the operations described above with respect to Non-Real Time RIC 1201 and/or Near-Real Time RIC 1203. For example, Non-Real Time RIC 1201 and/or Near-Real Time RIC 1203 may generate, refine, maintain, receive, implement, etc. one or more AI/ML models that include or are associated with respective input types 107, output tuning parameters 109, and/or tuned outputs 103, which may be used to optimize or configure elements of environment 1200. For example, Non-Real Time RIC 1201 and/or Near-Real Time RIC 1203 may utilize such AI/ML models to optimize or configure QoS parameters, queueing parameters, etc. associated with O-eNB 1205, O-CU-UP 1207, O-CU-CP 1209, O-DU 1211, and/or O-RU $013.

For example, a first O-eNB 1205 in a first location may be associated with a first input type 107, a first set of output tuning parameters 109, and/or a first tuned output 103, and a second O-eNB 1205 in a second location may be associated with a second input type 107, a second set of output tuning parameters 109, and/or a second tuned output 103. Additionally, or alternatively, a particular first O-eNB 1205 at a first time (e.g., a weekday) may be associated with a first input type 107, a first set of output tuning parameters 109, and/or a first tuned output 103, and the same O-eNB 1205 at a second time (e.g., a weekend) may be associated with a second input type 107, a second set of output tuning parameters 109, and/or a second tuned output 103. As yet another example, a particular first O-eNB 1205 under a first set of network conditions (e.g., in a "congested" state) may be associated with a first input type 107, a first set of output tuning parameters 109, and/or a first tuned output 103, and the same O-eNB 1205 under second set of network conditions (e.g., in a "not congested" state) may be associated with a second input type 107, a second set of output tuning parameters 109, and/or a second tuned output 103.

O-eNB 1205 may perform functions similar to those described above with respect to gNB 911 and/or eNB 913. For example, O-eNB 1205 may facilitate wireless communications between UE 901 and a core network. O-CU-CP 1207 may perform control plane signaling to coordinate the aggregation and/or distribution of traffic via one or more DUs 1103, which may include and/or be implemented by one or more O-DUs 1211, and O-CU-UP 1209 may perform the aggregation and/or distribution of traffic via such DUs 1103 (e.g., O-DUs 1211). O-DU 1211 may be communicatively coupled to one or more RUs 1101, which may include and/or may be implemented by one or more O-RUs 1213. In some embodiments, O-Cloud 1215 may include or be implemented by one or more MECs 914, which may provide services, and may be communicatively coupled, to O-CU-CP 1207, O-CU-UP 1209, O-DU 1211, and/or O-RU 1213 (e.g., via an O1 and/or O2 interface).

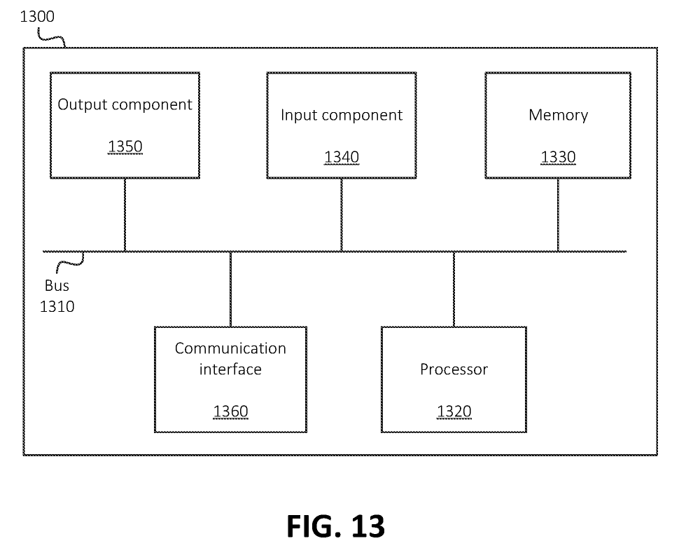

FIG. 13 illustrates example components of device 1300. One or more of the devices described above may include one or more devices 1300. Device 1300 may include bus 1310, processor 1320, memory 1330, input component 1340, output component 1350, and communication interface 1360. In another implementation, device 1300 may include additional, fewer, different, or differently arranged components.

Bus 1310 may include one or more communication paths that permit communication among the components of device 1300. Processor 1320 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1320 may be or may include one or more hardware processors. Memory 1330 may include any type of dynamic storage device that may store information and instructions for execution by processor 1320, and/or any type of non-volatile storage device that may store information for use by processor 1320.

Input component 1340 may include a mechanism that permits an operator to input information to device 1300 and/or other receives or detects input from a source external to input component 1340, such as a touchpad, a touchscreen, a keyboard, a keypad, a button, a switch, a microphone or other audio input component, etc. In some embodiments, input component 1340 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1350 may include a mechanism that outputs information to the operator, such as a display, a speaker, one or more light emitting diodes ("LEDs"), etc.

Communication interface 1360 may include any transceiver-like mechanism that enables device 1300 to communicate with other devices and/or systems (e.g., via RAN 910, RAN 912, DN 950, etc.). For example, communication interface 1360 may include an Ethernet interface, an optical interface, a coaxial interface, or the like. Communication interface 1360 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1300 may include more than one communication interface 1360. For instance, device 1300 may include an optical interface, a wireless interface, an Ethernet interface, and/or one or more other interfaces.

Device 1300 may perform certain operations relating to one or more processes described above. Device 1300 may perform these operations in response to processor 1320 executing instructions, such as software instructions, processor-executable instructions, etc. stored in a computer-readable medium, such as memory 1330. A computer-readable medium may be defined as a non-transitory memory device. A memory device may include space within a single physical memory device or spread across multiple physical memory devices. The instructions may be read into memory 1330 from another computer-readable medium or from another device. The instructions stored in memory 1330 may be processor-executable instructions that cause processor 1320 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-8), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
maintain a first set of artificial intelligence/machine learning ("AI/ML") models, wherein a particular AI/ML model of the first set of AI/ML models includes:
an association between a particular set of attributes and a particular input type, and
an association between the particular input type and a particular set of output tuning parameters;
generate a set of outputs using a second set of AI/ML models;
select a subset of outputs, from the set of outputs, based on the particular set of output tuning parameters;
associate the selected subset of outputs with the particular AI/ML model;
compare a set of attributes, associated with a received input, with the particular set of attributes included in the particular AI/ML model;
determine, based on the set of attributes, that the received input is associated with the particular input type with which the particular AI/ML model is associated;
identify the subset of outputs with which the particular AI/ML model is associated; and
provide a response to the received input, wherein the response is based on the identified subset of outputs with which the particular AI/ML model is associated.

2. The device of claim 1, wherein the one or more processors are further configured to:
perform a similarity analysis between the set of attributes, associated with the received input, and the particular set of attributes included in the particular AI/ML model,
wherein determining that the received input is associated with the particular input type includes determining that a measure of similarity, between the set of received input and the particular input type, exceeds a threshold measure of similarity.

3. The device of claim 1, wherein the particular AI/ML model is a first AI/ML model of the first set of AI/ML models, wherein the particular set of attributes included in the first AI/ML model is a first set of attributes, wherein the particular input type is a first input type, wherein the one or more processors are further configured to:
compare the set of attributes, associated with the received input, with a second set of attributes included in a second AI/ML model of the first set of AI/ML models,
wherein determining that the received input is associated with the first input type includes determining that a first measure of similarity, between the received input and the first input type, is greater than a second measure of similarity between the received input and a second input type with which the second AI/ML model is associated.

4. The device of claim 1, wherein the set of attributes, associated with the received input, include attributes of one or more network devices, and wherein the provided response includes a set of network configuration parameters, wherein the one or more network devices implement the set of network configuration parameters.

5. The device of claim 4, wherein the one or more network devices include a base station of a radio access network ("RAN"), wherein the set of network configuration parameters include a set of beamforming parameters.

6. The device of claim 1, wherein the second set of AI/ML models include one or more Natural Language Processing ("NLP") models, wherein the particular set of output tuning parameters includes language-based parameters.

7. The device of claim 1, wherein the provided response includes a particular output from the identified subset of outputs with which the particular AI/ML model is associated.

8. A non-transitory computer-readable medium, storing a plurality of processor-executable instructions to:
maintain a first set of artificial intelligence/machine learning ("AI/ML") models, wherein a particular AI/ML model of the first set of AI/ML models includes:
an association between a particular set of attributes and a particular input type, and
an association between the particular input type and a particular set of output tuning parameters;
generate a set of outputs using a second set of AI/ML models;
select a subset of outputs, from the set of outputs, based on the particular set of output tuning parameters;
associate the selected subset of outputs with the particular AI/ML model;
compare a set of attributes, associated with a received input, with the particular set of attributes included in the particular AI/ML model;
determine, based on the set of attributes, that the received input is associated with the particular input type with which the particular AI/ML model is associated;
identify the subset of outputs with which the particular AI/ML model is associated; and
provide a response to the received input, wherein the response is based on the identified subset of outputs with which the particular AI/ML model is associated.

9. The non-transitory computer-readable medium of claim 8, wherein the plurality of processor-executable instructions further include processor-executable instructions to:
perform a similarity analysis between the set of attributes, associated with the received input, and the particular set of attributes included in the particular AI/ML model,
wherein determining that the received input is associated with the particular input type includes determining that a measure of similarity, between the set of received input and the particular input type, exceeds a threshold measure of similarity.

10. The non-transitory computer-readable medium of claim 8, wherein the particular AI/ML model is a first AI/ML model of the first set of AI/ML models, wherein the particular set of attributes included in the first AI/ML model is a first set of attributes, wherein the particular input type is a first input type, wherein the plurality of processor-executable instructions further include processor-executable instructions to:
compare the set of attributes, associated with the received input, with a second set of attributes included in a second AI/ML model of the first set of AI/ML models,
wherein determining that the received input is associated with the first input type includes determining that a first measure of similarity, between the received input and the first input type, is greater than a second measure of similarity between the received input and a second input type with which the second AI/ML model is associated.

11. The non-transitory computer-readable medium of claim 8, wherein the set of attributes, associated with the received input, include attributes of one or more network devices, and wherein the provided response includes a set of network configuration parameters, wherein the one or more network devices implement the set of network configuration parameters.

12. The non-transitory computer-readable medium of claim 11, wherein the one or more network devices include a base station of a radio access network ("RAN"), wherein the set of network configuration parameters include a set of beamforming parameters.

13. The non-transitory computer-readable medium of claim 8, wherein the second set of AI/ML models include one or more Natural Language Processing ("NLP") models, wherein the particular set of output tuning parameters includes language-based parameters.

14. The non-transitory computer-readable medium of claim 8, wherein the provided response includes a particular output from the identified subset of outputs with which the particular AI/ML model is associated.

15. A method, comprising:
maintaining a first set of artificial intelligence/machine learning ("AI/ML") models, wherein a particular AI/ML model of the first set of AI/ML models includes:
an association between a particular set of attributes and a particular input type, and
an association between the particular input type and a particular set of output tuning parameters;
generating a set of outputs using a second set of AI/ML models;
selecting a subset of outputs, from the set of outputs, based on the particular set of output tuning parameters;
associating the selected subset of outputs with the particular AI/ML model;
comparing a set of attributes, associated with a received input, with the particular set of attributes included in the particular AI/ML model;
determining, based on the set of attributes, that the received input is associated with the particular input type with which the particular AI/ML model is associated;
identifying the subset of outputs with which the particular AI/ML model is associated; and
providing a response to the received input, wherein the response is based on the identified subset of outputs with which the particular AI/ML model is associated.

16. The method of claim 15, further comprising:
performing a similarity analysis between the set of attributes, associated with the received input, and the particular set of attributes included in the particular AI/ML model,
wherein determining that the received input is associated with the particular input type includes determining that a measure of similarity, between the set of received input and the particular input type, exceeds a threshold measure of similarity.

17. The method of claim 15, wherein the particular AI/ML model is a first AI/ML model of the first set of AI/ML models, wherein the particular set of attributes included in the first AI/ML model is a first set of attributes, wherein the particular input type is a first input type, the method further comprising:
comparing the set of attributes, associated with the received input, with a second set of attributes included in a second AI/ML model of the first set of AI/ML models,
wherein determining that the received input is associated with the first input type includes determining that a first measure of similarity, between the received input and the first input type, is greater than a second measure of similarity between the received input and a second input type with which the second AI/ML model is associated.

18. The method of claim 15, wherein the set of attributes, associated with the received input, include attributes of one or more base stations of a radio access network ("RAN") of a wireless network, and wherein the provided response includes a set of beamforming parameters, wherein the one or more base stations implement the set of beamforming parameters.

19. The method of claim 15, wherein the second set of AI/ML models include one or more Natural Language Processing ("NLP") models, wherein the particular set of output tuning parameters includes language-based parameters.

20. The method of claim 15, wherein the provided response includes a particular output from the identified subset of outputs with which the particular AI/ML model is associated.
